(19) United States
(12) Patent Application Publication
(10) Pub. No.: US 2009/0066800 A1
(43) Pub. Date: Mar. 12, 2009

(54) METHOD AND APPARATUS FOR IMAGE OR VIDEO STABILIZATION

(75) Inventor: Dennis Wei, Cambridges, MA (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/205,583

(22) Filed: Sep. 5, 2008

Related U.S. Application Data
(60) Provisional application No. 60/970,403, filed on Sep. 6, 2007.

(51) Int. Cl. H04N 5/232

(52) U.S. Cl. 348/208.99; 348/E05.046

(57) ABSTRACT

A stabilization method and apparatus for at least one of an image or a video. The stabilization method comprising estimating inter-frame translation, inter-frame rotation and intentional motion, utilizing the estimation for determining motion compensation, and performing the motion compensation utilizing the determined motion compensation.

### CROSS-REFERENCE TO RELATED APPLICATIONS

This application claims benefit of U.S. provisional patent application Ser. No. 60/970,403, filed Sep. 6, 2007, which is herein incorporated by reference.

### BACKGROUND OF THE INVENTION

1. Field of the Invention

Embodiments of the present invention generally relate to a method and apparatus for video or image stabilization.

2. Description of the Related Art

Video captured by handheld recording devices often suffers from unwanted motion. In particular, unwanted rotational motion can be significant if the user is walking or otherwise moving. Reducing unwanted translational or rotational motion improves video quality and ease of viewing.

Therefore, there is a need for a method and apparatus for reducing unwanted translation or rotation motion.

### SUMMARY OF THE INVENTION

Embodiments of the present invention relate to a stabilization method and apparatus for at least one of an image or a video. The stabilization method comprising estimating inter-frame translation, inter-frame rotation and intentional motion, utilizing the estimation for determining motion compensation, and performing the motion compensation utilizing the determined motion compensation.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts an embodiment of a top-level block diagram of a stabilization method;

FIG. 2 depicts an embodiment of a motion compensated output frame;

FIG. 3 depicts an embodiment of blocks for translation estimation;

FIG. 4 depicts an embodiment of a motion estimation using boundary signals;

FIG. 5 depicts an embodiment of a feature selection and motion estimation;

FIG. 6 depicts an embodiment for computing sum of absolute differences (SAD) profiles of a feature;

FIG. 7 depicts an embodiment for a criteria for evaluating sum of absolute differences (SAD) profiles;

FIG. 8 depicts an embodiment for a first level of iterative fitting procedure; and

FIG. 9 depicts an exemplary high-level block diagram of image or video stabilization system.

### DETAILED DESCRIPTION

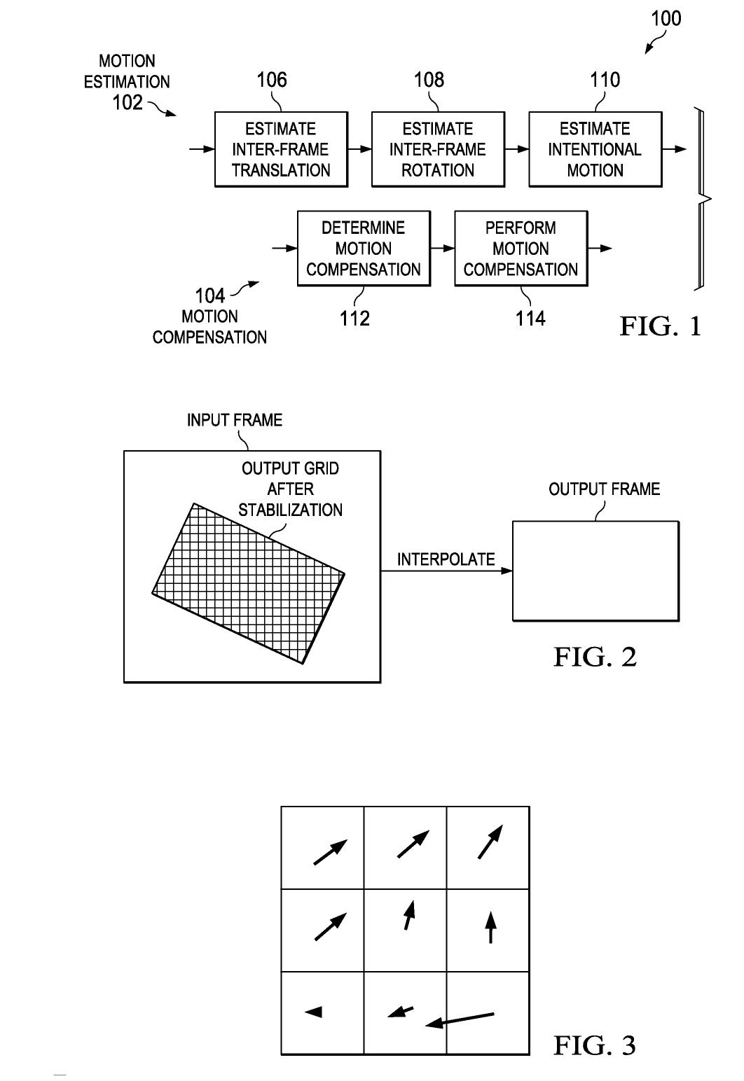

FIG. 1 depicts an embodiment of a top-level block diagram of a rotational stabilization method 100. The procedure used to process each frame includes two portions. As shown in FIG. 1, the first portion is motion estimation 102 and the second portion is motion compensation 104. In one embodiment, real-time video stabilization utilizes digital processing instead of a mechanical apparatus.

Motion estimation 102 includes three phases, which are the estimation of translational motion 106 phase, the estimation of rotational motion 108 phase and the estimation of intentional motion 110 phase. The estimation of translational motion 106 phase and the estimation of rotational motion 108 phase estimate the translational and rotational motion of the current frame relative to the previous frame, i.e., the inter-frame motion of the camera. The estimation of intentional motion 110 phase estimates the component of the total motion that is intentional and does not require correction, such as, motion due to deliberate panning, zooming, or movement of the camera user.

Shown in Equation 1 is a motion model that may be employed. The motion model includes a 4-parameter affine model, which includes four (4) parameters dₓ, d_{y}, c and s. Parameters dₓ and d_{y} describe translation and parameters c and s describe rotation and zoom. According to the model, a point (x, y) in the current frame moves to the location (x′, y′) in the next frame given by:

$$[ \begin{matrix}{x}^{′} \\ {y}^{′}\end{matrix} ] = \underbrace{[ \begin{matrix}1 + c & - s \\ s & 1 + c\end{matrix} ]}_{A} [ \begin{matrix}x \\ y\end{matrix} ] + \underbrace{[ \begin{matrix}{d}_{x} \\ {d}_{y}\end{matrix} ]} . \qquad ( Equation 1 )$$

In addition, the method makes use of a 2-parameter translation-only model, corresponding to setting c=s=0.

Motion compensation is composed of two phases, the determination of motion compensation 112 phase and the output of the motion-compensated frame 114 phase. As illustrated in FIG. 2, the output frame should be smaller than the input frame in order to accommodate a compensating transformation, while allowing the output values to be interpolated from the input frame. The question of how much smaller is a trade-off between the output frame size and the maximum compensation amplitude.

Before applying motion compensation, the grid of output pixels is nominally centered and aligned with respect to the input frame. In the determination of motion compensation phase, the estimates of total and intentional motion from the motion estimation phases are used to compute the transformation applied to the output grid to compensate for unintentional motion. FIG. 2 shows the effect of one such transformation. The output of the motion-compensated frame 114 phase performs the motion compensation and interpolation specified by the determination of motion compensation phase and stores the resulting output frame.

In the estimation of inter-frame translation 106 phase, the method estimates the inter-frame translation of the current frame, represented by the parameters dₓ and d_{y}. For this purpose, the frame is divided into nine (9) rectangular blocks, arranged in a 3×3 rectangular grid, as shown in FIG. 3. Translational motion estimates, motion vectors, are obtained for each block, from which the translation of the camera is inferred.

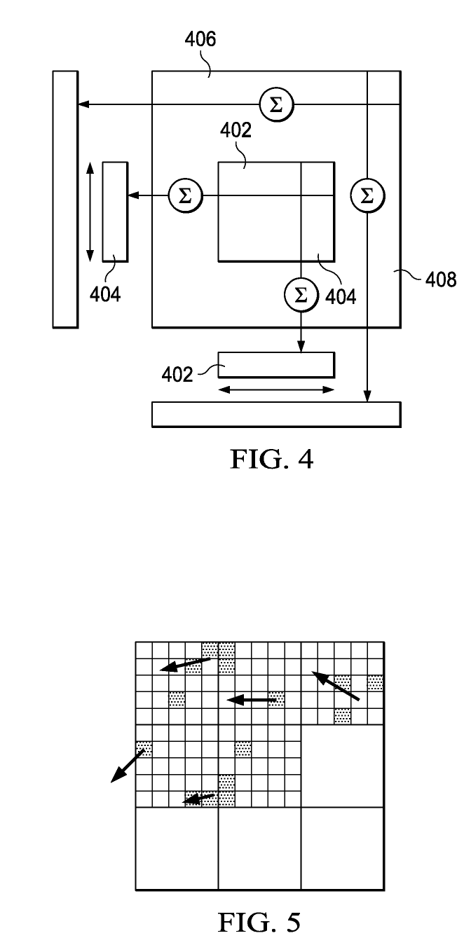

FIG. 4 depicts the method used to estimate the motion of each block. First, the pixel values within the block are projected (i.e. summed) along the vertical and horizontal directions, yielding one-dimensional (1-D) sequences termed the horizontal boundary signal 402 and vertical boundary signal 404, respectively. Boundary signals are correlated against the corresponding boundary signals from the previous frame, 406 and 408, specifically using the minimum sum of absolute differences (SAD) criterion. The displacement resulting in the minimum SAD between corresponding horizontal boundary signals is taken to be the horizontal component of the motion vector, and similarly for the vertical component.

The search ranges for motion estimation are chosen to be a fraction of the corresponding frame dimension, for example, ±5% of the frame width/height. The quality of the translation estimates is measured by the SAD derivative, the difference between the minimum SAD and the SADs at displacements adjacent to the minimum.

A segmentation procedure is applied to the motion vectors from the nine (9) blocks of FIG. 3 to estimate the translation of the frame as a whole. Blocks with excessively large motion vectors or low SAD derivatives are eliminated as being unreliable. The remaining block motion vectors are grouped into clusters consisting of similar motion vectors. Each cluster is assigned a score according to three criteria, which are (1) size (the number of blocks it contains), (2) overlap with the cluster selected from the previous frame (the number of blocks shared in common), and (3) the average motion vector of its constituent blocks relative to the estimated intentional translation of the frame (estimated for the previous frame in the estimate intentional motion 110 phase of FIG. 1). Large clusters with significant overlap and small relative motion are favored. The average motion vector of the cluster with the highest score is chosen as the translation estimate for the frame, and the membership of the selected cluster is retained for use in the estimate inter-frame rotation 108 phase and in the estimate inter-frame translation 106 phase for the next frame, shown in FIG. 1.

If the segmentation does not yield a valid selected cluster, the process is repeated using the horizontal and vertical components of the block motion vectors separately. If both the horizontal and vertical segmentation succeed in estimating the corresponding components dₓ and d_{y} of the frame translation, the component associated with the higher cluster score may be accepted. Consequently, either dₓ or d_{y} may be estimated even when both cannot be simultaneously estimated.

In the estimate inter-frame rotation 108 phase, the method estimates the inter-frame rotation of the current frame and seeks to refine the translation estimate from the estimate inter-frame translation 106 phase. The estimate inter-frame rotation 108 phase is undertaken when the full two-dimensional (2-D) translation estimation succeeds and/or when the cluster selected in the estimate inter-frame translation 106 phase contains a sufficient number of blocks, for example, 3 out of 9 blocks. If the selected cluster contains more blocks than the threshold allowed under complexity constraints, for example, 6 out of 9, the blocks with the lowest SAD derivatives are eliminated.

The estimate inter-frame rotation 108 phase can be divided in turn into three stages. The first stage identifies the features, which are the dashed blocks shown in FIG. 5, that are suitable for refining the previous motion estimates. The translation of the selected features is estimated in the second stage, represented by arrows in FIG. 5. The third stage fits the feature motion vectors to the affine model describing the motion of the camera.

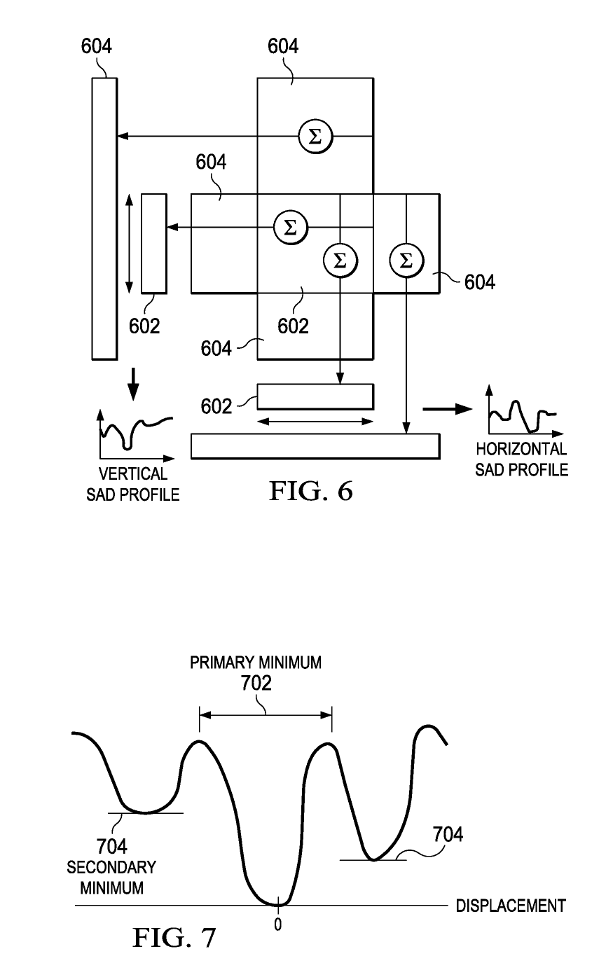

In the first stage of the estimate inter-frame rotation 108 phase, each block is subdivided into a number of smaller rectangular blocks, for example, 25 smaller blocks, or “features”. The smaller blocks or features are arranged in a 5×5 rectangular grid. To evaluate the features, boundary signals 602 of FIG. 6 are computed as described in the estimate inter-frame translation 106 phase, shown in FIG. 1, for each feature and for the surrounding region 604 in the current frame. The horizontal and vertical boundary signals from each feature are used to construct two 1-D SAD profiles, for example, SAD values as a function of displacement, where the SAD is computed between boundary signals corresponding to the feature and to its surrounding region. The SAD profiles thus characterize the dissimilarity of the feature to its surroundings.

For the SAD profiles, the method measures the depth of the primary minimum 702 surrounding zero displacement, as shown in FIG. 7, and the depths of any secondary minima 704 that may be confused with the primary minimum 702. The shallower, for example, worst-case, of the two primary minimum 702 depths is recorded, and similarly for the secondary minimum 704 depths. Each feature is then assigned a score based on the primary minimum 702 and secondary minimum 704 depths of its SAD profiles, and the distance to the geometric centre of the frame. The three (3) best features according to these criteria are selected from each block.

The estimate inter-frame rotation 108 phase of FIG. 1 estimates the translation of all selected features, using a more conventional block-matching method as opposed to the boundary signal method of the estimate inter-frame translation 106 phase of FIG. 1. For each feature, 2-D SADs are computed at various displacements between the feature in the current frame and a corresponding search area in the previous frame. The motion vector of the block containing the feature (obtained in the estimate inter-frame translation 106 phase) is used as a nominal motion estimate. The 2-D displacement resulting in the smallest SAD is taken to be the motion vector of the feature.

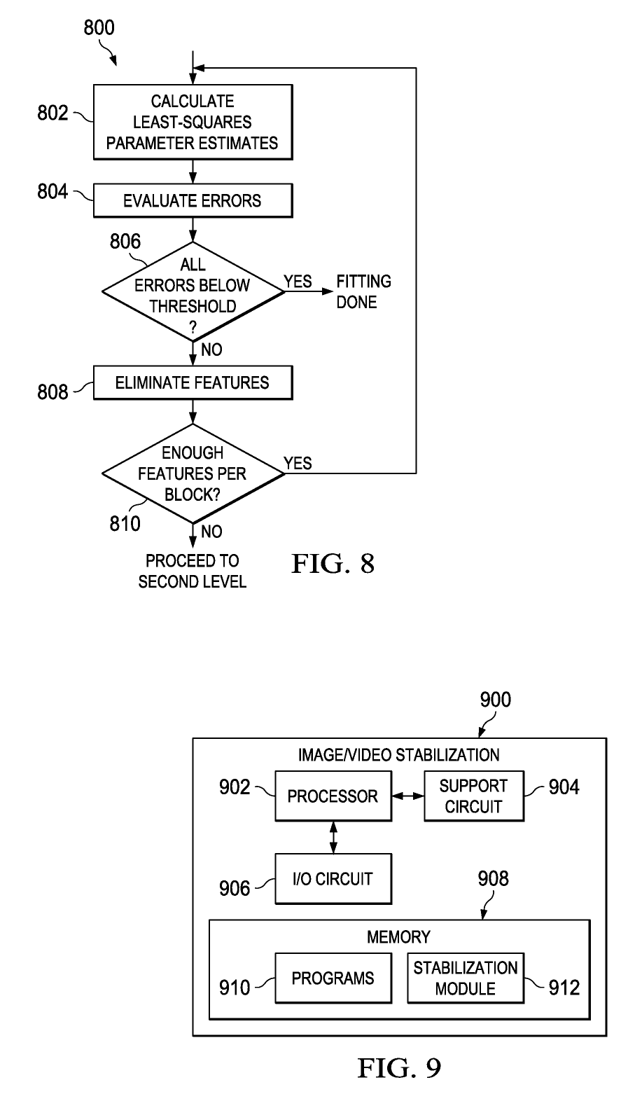

The third stage of the estimate inter-frame rotation 108 phase fits the positions and motion vectors of all selected features to the affine motion model. The fitting procedure is iterative and is divided into two levels. The first level is a method 800 shown in FIG. 8. The method 800 starts at step 802, in which the method 800 performs least-squares estimation of, for example, 4 parameters (may be done simultaneously). In step 804, every time a set of parameter values is obtained, errors are evaluated, which entails the evaluation of the discrepancy between the measured motion vector and the motion vector predicted by the model for each feature.

In step 806, if the maximum discrepancy falls below a threshold, for example, four (4) pixels for VGA frames, the parameter values are retained and the estimation is declared a success. Otherwise, the method 800 proceeds to step 808, wherein the procedure eliminates features for which the discrepancy exceeds the threshold before repeating the fitting on the reduced feature set. At step 808, if there are enough features per block, then the method 800 proceeds to step 802. The first level may iterate until the number of features remaining in any block falls below a threshold, for example, 2 out of 3.

If there are not enough features per block, the method 800 passes to the second level. In the second level, the translation parameters dₓ and d_{y} are fixed at the values estimated from the estimate inter-frame translation 106 (FIG. 1) phase and the rotation/zoom parameters c and s are updated.

The second level employs a feature elimination strategy similar to that of the first level. The fitting terminates when no features are eliminated. In such case, the values of c and s are retained. The fitting may also terminate when the number of features in any block falls below a second threshold, for example, 1 out of 3). In such case, the rotation estimation is deemed to have failed. Motion parameters that cannot be successfully estimated are set to zero.

In the estimate intentional motion 110 (FIG. 1) phase, the method estimates the intentional component of the total frame motion. Intuitively, longer-term trends in the total motion are regarded as intentional, while more rapid fluctuations are attributed to unintentional motion.

To estimate the intentional motion, the inter-frame motion parameters estimated in the estimate inter-frame translation 106 and the estimate inter-frame rotation 108 phases of FIG. 1 are used to calculate cumulative motion parameters, for example, those describing the motion of the current frame relative to the first frame in the sequence. As shown in Equation 2, four (4) parameters are propagated according to the affine motion model as follows:

A_{cum}[n]=A[n]A_{cum}[n−1]

d_{cum}[n]=A[n]d_{cum}[n−1]+d[n]′ (Equation 2)

where A and d are a shorthand representation for the motion parameters, as in Equation 1. As shown in Equation 3, two (2) additional parameters, denoted by the vector t, are propagated according to a translation-only model.

t_{cum}[n]=t_{cum}[n−1]+d[n] (Equation 3)

Thus, there are six (6) cumulative motion parameters in total. The first difference is computed for each of the six (6) cumulative motion parameters.

Intentional motion estimation is performed separately for each cumulative parameter using both the current value, which is the “position” measurement, and the first difference, which is the “velocity” measurement. As shown in Equation 4, both the position and velocity measurements, denoted generically by x and Δx, are lowpass filtered using a 1^{st}-order recursive filter to produce estimates of the intentional position and velocity, denoted by carets in Equation 4:

\hat{x}[n|n]=α₁x[n]+(1−α₁)\hat{x}[n|n−1]

Δ\hat{x}[n]=α₂Δx[n]+(1−α₂)Δ\hat{x}[n−1] (Equation 4)

Typical values for the filter coefficients are α₁=α₂=0.05 for translation parameters and α₁=α₂=0.10 for rotation/zoom parameters. In addition, the coefficient α₁ for the position lowpass filter is scaled proportionally to the absolute difference between the previously estimated intentional position x̂[n|n−1] and the current measurement x[n]. In Equation 5, the estimated intentional velocity is used to predict the intentional position estimate for the next frame:

\hat{x}[n+1|n]=\hat{x}[n|]+Δ\hat{x}[n]. (Equation 5)

After the cumulative intentional motion parameters have been estimated as above, the method computes four (4) inter-frame intentional motion parameters. If the rotation estimation in the estimate inter-frame rotation 108 phase was successful, the affine motion model is used, corresponding to the Equations 6:

Â[n]=Â_{cum}[n]Â_{cum}⁻¹[n−1]

\hat{d}[n]=\hat{d}_{cum}[n]−Â[n]\hat{d}_{cum}[n−1] (Equation 6)

Otherwise, the two (2) parameters of the translation-only model are used, as given in Equation 7:

\hat{d}[n]=\hat{t}_{cum}[n]−\hat{t}_{cum}[n−1]. (Equation 7)

Intentional motion parameters corresponding to failed motion estimates are set to zero. Intended motion in the rotation direction is typically uncommon; therefore, it is possible to consider the rotational motion as purely unintentional. Then, in the determine motion compensation 112 (FIG. 1) phase, the frame rotation is compensated for. When the rotational motion is removed, there is a need to know which direction is vertical. This problem may be solved by assuming that the camera is held vertically on average.

In the determine motion compensation 112 (FIG. 1) phase, the estimates of total and intentional inter-frame motion, obtained from the motion estimation 102 portion, are used to update the four motion compensation parameters. In essence, the objective is to compensate for the total motion of the frame before re-applying the intentional motion. Depending on the availability of rotation estimates, either the 4-parameter affine model in Equation 8 or the 2-parameter translation model in equation 9 may be used.

Ã[n]=A[n]Ã[n−1]Â⁻¹[n]

\tilde{d}[n]=A[n]\tilde{d}[n−1]+d[n]−Ã[n]\hat{d}[n]′ (Equation 8)

\tilde{d}[n]=\tilde{d}[n−1]+d[n]−\hat{d}[n] (Equation 9)

Range-checking and limiting is performed to ensure that the output grid does not extend beyond the boundaries of the input frame. Motion compensation (horizontal, vertical, or rotational) is disabled when the corresponding motion estimate is unavailable or when the magnitude of intentional motion or acceleration is determined to be too large for reliable stabilization. After a disabling event, motion compensation is gradually re-enabled over a period of a number of frames, for example, ten (10) frames to reduce abrupt changes in compensation.

The perform motion compensation 114 phase performs the motion compensation specified by the parameters determined in the determine motion compensation 112 (FIG. 1) phase. The compensating transform is applied to the nominal output pixel locations to calculate the coordinates of the stabilized output pixels. The corresponding pixel values are computed from the input frame using bilinear interpolation. The output frame is then stored in an appropriate location. This completes the stabilization procedure for a single frame.

Both the motion estimation and motion compensation in our method are structured to operate at different levels of refinement and complexity, for example, 2-D translation and rotation described by a 4-parameter model, 2-D translation described by a 2-parameter model, and/or translation in one direction only. The different levels can accommodate scenes of varying suitability for stabilization.

In static scenes, the full capabilities of the method may be exercised to produce a highly stabilized output. In more dynamic or complex scenes, some stabilization may still be achieved, while the problem of incorrectly estimating motion from unreliable data may be mitigated. Hence, such a solution is more robust than a non-tiered solution. In addition, when a component of motion compensation is disabled, gradually re-enabling it reduces the distracting appearance of a sudden return to full compensation.

Using boundary signals to estimate motion and to evaluate SAD profiles dramatically decreases the number of computations as compared to conventional block-matching methods while maintaining a comparable level of accuracy. The savings in computation is due to order of magnitude decreases both in object size, for example, two 1-D boundary signals of length 100 versus one 2-D block of size 100×100, and in search range, for example, two 1-D search ranges of size 10 versus one 2-D search range of size 10×10. Furthermore, the complexity of boundary signal methods scales linearly with the dimensions of the frame; whereas, block-matching methods scale quadratically.

The challenge of avoiding moving objects while estimating camera motion may be addressed principally by two (2) elements in our method, which are segmentation of block motion vectors and an iterative procedure for fitting feature motion vectors. At a coarser level, the segmentation of block motion vectors prevents larger moving objects from influencing the translation estimation. At a finer level, the rejection of features with outlying motion vectors prevents smaller moving objects from corrupting both translation and rotation estimates.

Estimating intentional motion is an important aspect of stabilizing video recorded by mobile devices. Without it, the motion compensation may be overwhelmed by deliberate, consistent movements, such as, panning or walking toward the subject; and thus is unable to compensate for unwanted motion. The use of 1^{st}-order recursive filters may allow the reproduction of natural-looking intentional motion while keeping computation and memory requirements low. As a result, the solution may incorporate first difference information and an adaptive strategy in order to better track large intentional movements or changes in direction.

FIG. 9 depicts an exemplary high-level block diagram of an image or video stabilization system 900. FIG. 9 depicts a general-purpose computer 900 suitable for use in performing the methods described above, such as, an image or video capturing apparatus, camera, camcorder, cell phone and the like. The stabilization system 900 includes a processor 902, support circuit 904, input/output (I/O) circuits 906 and memory 908.

The processor 902 may comprise one or more conventionally available microprocessors. The microprocessor may be an application specific integrated circuit (ASIC). The support circuits 904 are well known circuits used to promote functionality of the processor 902. The support circuits 904 include, but are not limited to, a cache, power supplies, clock circuits, and the like. The memory 908 is any computer readable medium. The memory 908 may comprise random access memory, read only memory, removable disk memory, flash memory, and various combinations of these types of memory. The memory 908 is sometimes referred to as main memory and may, in part, be used as cache memory or buffer memory. The memory 908 includes programs 910 and a stabilization module 912.

As such, the processor 902 cooperates with stabilization module 912 in executing the software routines and/or programs 910 in the memory 908 to perform the steps discussed herein. The software processes may be stored or loaded to memory 908 from a storage device (e.g., an optical drive, floppy drive, disk drive, etc.) and implemented within the memory 908 and operated by the processor 902. Thus, various steps and methods of the present invention may be stored on a computer readable medium.

The I/O circuit 906 may form an interface between the various functional elements communicating with the system 900. The I/O circuits 906 may be internal, external or coupled to the system 900. For example, in the system 900 communicates with other devices, such as, a computer, storage unit, and/or handheld device, through a wired and/or wireless communications link for the transmission of compressed or decompressed data.

FIG. 9 depicts a system that is programmed to perform various functions in accordance with the present invention, the term computer is not limited to just those integrated circuits referred to in the art as computers, but broadly refers to computers, processors, microcontrollers, microcomputers, programmable logic controllers, application specific integrated circuits, and other programmable circuits, and these terms are used interchangeably herein.

While the foregoing is directed to embodiments of the present invention, other and further embodiments of the invention may be devised without departing from the basic scope thereof, and the scope thereof is determined by the claims that follow.

What is claimed is:

1. A stabilization method for at least one of an image or a video, comprising:
estimating inter-frame translation, inter-frame rotation and intentional motion;
utilizing the estimation for determining motion compensation; and
performing the motion compensation utilizing the determined motion compensation.

2. The stabilization method of claim 1, wherein the stabilization method utilizes at least one of a tiered motion estimation or a tiered motion compensation comprising at least one of multi-dimensional translation and rotation, multi-dimensional translation or single dimensional translation.

3. The stabilization method of claim 1, wherein the stabilization method is utilized in real-time video stabilization, and wherein the real-time video stabilization utilizes digital processing.

4. The stabilization method of claim 1, wherein the estimation step comprises:
identifying features from at least one block suitable for refining the motion estimates;
estimating inter-frame translation of the identified features; and
fitting the feature motion vectors to an affine model describing motion of at least one of the image or the video.

5. The stabilization method of claim 4, wherein at least one boundary signal is utilized for at least one of estimating the motion of at least one block or evaluating sum of absolute differences profiles of a feature.

6. The stabilization method of claim 4, wherein the fitting step rejects outlying feature motion vectors and estimates parameters, depending on data quality of the at least one of image or video.

7. The stabilization method of claim 1, wherein the estimation of intentional motion avoids compensating for deliberate camera movement.

8. The stabilization method of claim 1, wherein the estimation of intentional motion comprises incorporating measurements of at least one of first differences or cumulative motion parameters of a current frame of at least one of the image or the video.

9. The stabilization method of claim 1, wherein the step of determining motion compensation comprises ensuring that an output grid does not extend beyond frame boundaries of at least one of the image or the video.

10. The stabilization method of claim 9, wherein the ensuring step comprising:
disabling motion compensation when at least one of the corresponding motion estimates is unavailable or when the magnitude of intentional motion is determined to be too large for reliable stabilization; and
gradually re-enabled motion compensation over a period of a number of frames to reduce abrupt changes in compensation.

11. The stabilization method of claim 1, wherein the disabling and the gradual re-enabling of motion compensation are performed due to low reliability.

12. An apparatus utilized for stabilizing at least one of an image or a video, comprising:
means for estimating inter-frame translation, inter-frame rotation and intentional motion;
means for utilizing the estimation for determining motion compensation; and
means for performing the motion compensation utilizing the determined motion compensation.

13. The apparatus of claim 12, wherein at least one boundary signal is utilized for at least one of estimating the motion of at least one block or evaluating sum of absolute differences profiles of features.

14. The apparatus of claim 12, wherein the means for estimating comprises:
means for identifying features from at least one block suitable for refining the motion estimates;
means for estimating inter-frame translation of the identified features; and
means for fitting the feature motion vectors to an affine model describing the motion of at least one of the image or the video.

15. The apparatus of claim 14, wherein the means for fitting rejects outlying features and estimates parameters, depending on data quality of the at least one of image or video.

16. The apparatus of claim 12, wherein the estimation of intentional motion avoids compensating for deliberate camera movements.

17. The apparatus of claim 12, wherein the estimation of intentional motion comprises a means for incorporating measurements of at least one of first differences or cumulative motion parameters of the current frame of at least one of the image or the video.

18. The apparatus of claim 12, wherein the estimation for determining motion compensation comprises ensuring that the output grid does not extend beyond frame boundaries of at least one of the image or the video.

19. The apparatus of claim 18, wherein the ensuring that the output grid does not extend beyond the frame boundaries, comprising:
means for disabling motion compensation when at least one of the corresponding motion estimates is unavailable or when magnitude of intentional motion or acceleration is determined to be too large for reliable stabilization; and
means for gradually re-enabled motion compensation over a period of a number of frames to reduce abrupt changes in compensation.

20. A computer readable medium comprising instruction when executed by a computer performs a stabilization method, the stabilization method comprising:
estimating inter-frame translation, inter-frame rotation and intentional motion;
utilizing the estimation for determining motion compensation; and
performing the motion compensation utilizing the determined motion compensation.
